(19) United States
(12) Patent Application Publication
(10) Pub. No.: US 2026/0303422 A1
(43) Pub. Date: Oct. 1, 2026

(54) SIMPLIFIED LOG-LIKELIHOOD RATIO DEMAPPER

(71) Applicant: Silicon Laboratories Inc., Austin, TX (US)

(72) Inventors: Xushuai Qu, Austin, TX (US); Guner Arslan, Austin, TX (US); Wentao Li, Mountain House, CA (US)

(21) Appl. No.: 19/093,879

(22) Filed: Mar. 28, 2025

(51) Int. Cl. H04L 27/22

(52) U.S. Cl. CPC H04L 27/22

(57) ABSTRACT

A technique for reducing complexity and power consumption of generation of Log-Likelihood Ratio (LLR) values in a Phase-Shift Keying digital communications system includes rotating a received symbol and providing the rotated symbols to a simplified LLR demapper that generates an LLR value for each coded bit of the phase-rotated received symbol based on the phase-rotated received symbol and a set of predetermined scalar values. An embodiment of the simplified LLR demapper includes scaling circuits that multiply the signal components and scalar values using shift and add operations. A select circuit selects outputs of the scaling circuits as in-phase and quadrature components of the LLR values for each coded bit of the received symbol based on a control code generated based on the rotated symbol. The simplified LLR demapper combines the outputs of the select circuits to generate the LLR values for each coded bit of the received symbol.

### BACKGROUND

### Field of the Invention

This disclosure relates to communications systems in general, and more particularly to receivers of wireless communications systems.

### Description of the Related Art

In an exemplary wireless communications system, e.g., a wireless communications system compliant with a Bluetooth® Low Energy (BLE) High Data Throughput (HDT) communications protocol, phase-shift keying is used to modulate digital data. A receiver demodulates symbols received from the communication channel using a soft-decision algorithm that generates logarithmic representations of bit probabilities (i.e., soft-decisions) referred to as Log-Likelihood Ratio (LLR) values. Calculation of the LLR values is complex and uses a substantial amount of processing capability and power consumption. Accordingly, improved techniques for generating LLR values are desired.

### SUMMARY OF EMBODIMENTS OF THE INVENTION

In at least one embodiment, a receiver of a digital communications system using shift keying digital modulation includes a receive path configured to provide a baseband received symbol. The receiver includes a phase shifting circuit configured to rotate the baseband received symbol to generate a phase-rotated received symbol. The receiver includes a log-likelihood ratio (LLR) demapper configured to generate an LLR value for each coded bit of the phase-rotated received symbol based on the phase-rotated received symbol and a set of predetermined scalar values. An embodiment of the LLR demapper includes a scaling circuit configured to scale an in-phase component of the phase-rotated received symbol by each of a plurality of predetermined scalar values to generate a plurality of scaled in-phase symbol components. An embodiment of the scaling circuit is configured to scale a quadrature component of the phase-rotated received symbol by each of the plurality of predetermined scalar values to generate a plurality of scaled quadrature symbol components.

An embodiment of the LLR demapper includes a first select circuit configured to provide a selected scaled in-phase symbol component for each coded bit of the phase-rotated received symbol based on a plurality of scaled in-phase symbol components and a control code. The embodiment of the LLR demapper further includes a second select circuit configured to provide a selected scaled quadrature symbol component for each coded bit of the phase-rotated received symbol based on a plurality of scaled quadrature symbol components and the control code. The embodiment of the LLR demapper further includes a summing circuit configured to combine each selected scaled in-phase symbol component and corresponding selected scaled quadrature symbol component to generate the LLR value for each coded bit of the phase-rotated received symbol.

An embodiment of the LLR demapper includes a region detector configured to generate a control code based on a first comparison of an in-phase component of the phase-rotated received symbol to zero, a second comparison of a quadrature component of the phase-rotated received symbol to zero, and a comparison of the in-phase component of the phase-rotated received symbol to the quadrature component of the phase-rotated received symbol. In an embodiment, the control code corresponds to a region of a Phase-Shift Keying (PSK) constellation diagram identified by the phase-rotated received symbol. In an embodiment, the shift keying digital communications system is an 8-PSK digital communications system, the phase shifting circuit rotates the baseband received symbol by π/8 counterclockwise with respect to Cartesian coordinate axes of a constellation diagram, and the received symbol includes three coded bits. In an embodiment, the phase shifting circuit is a Kalman filter PLL included in a phase or frequency offset correction circuit.

In at least one embodiment, a method for calculating LLR values in a digital communications system using shift keying digital modulation includes phase shifting a baseband received symbol to generate a phase-rotated received symbol. The method includes generating an LLR value for each coded bit of the phase-rotated received symbol based on the phase-rotated received symbol and a set of predetermined scalar values. In an embodiment, generating the LLR value for each coded bit of the phase-rotated received symbol includes scaling an in-phase component of the phase-rotated received symbol by each of a plurality of predetermined scalar values to generate a plurality of scaled in-phase symbol components. In an embodiment, generating the LLR value for each coded bit of the phase-rotated received symbol includes scaling a quadrature component of the phase-rotated received symbol by each of the plurality of predetermined scalar values to generate a plurality of scaled quadrature symbol components.

In an embodiment, generating the LLR value for each coded bit of the phase-rotated received symbol includes selecting from a plurality of scaled in-phase symbol components according to a control code, a selected scaled in-phase symbol component for each coded bit of the phase-rotated received symbol. In an embodiment, generating the LLR value for each coded bit of the phase-rotated received symbol includes selecting from a plurality of scaled quadrature symbol components according to the control code, a selected scaled quadrature symbol component for each coded bit of the phase-rotated received symbol. In an embodiment, generating the LLR value for each coded bit of the phase-rotated received symbol includes combining each selected scaled in-phase symbol component and corresponding selected scaled quadrature symbol component to generate the LLR value for each coded bit of the phase-rotated received symbol.

In an embodiment, generating the LLR value for each coded bit of the phase-rotated received symbol includes providing a control code based on a first comparison of an in-phase component of the phase-rotated received symbol to zero, a second comparison of a quadrature component of the phase-rotated received symbol to zero, and a comparison of the in-phase component of the phase-rotated received symbol to the quadrature component of the phase-rotated received symbol. In an embodiment, the control code corresponds to a region of a Phase-Shift Keying PSK constellation diagram identified by the phase-rotated received symbol. In an embodiment, the method includes compensating for a phase or frequency offset in the baseband received symbol, the compensating includes Kalman filtering the baseband received symbol, and the phase shifting is performed by the compensating.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary wireless communications system.

FIG. 2 illustrates a functional block diagram of an exemplary receiver of the exemplary wireless communications receiver of FIG. 1.

FIG. 3 illustrates a functional block diagram of an exemplary demodulator of the wireless communications receiver of FIG. 1.

FIG. 4 illustrates a functional block diagram of an exemplary LLR demapper including a phase shifter and simplified LLR demapper.

FIG. 5 illustrates an 8-PSK constellation diagram.

FIG. 6 illustrates a rotated 8-PSK constellation diagram.

FIG. 7 illustrates a functional block diagram of an exemplary demodulator including a simplified LLR demapper and a Kalman filter-based Phase-Locked Loop (PLL) incorporating phase rotation.

FIG. 8 illustrates a functional block diagram of an exemplary Kalman filter-based Phase-Locked Loop (PLL) incorporating phase rotation coupled to a simplified LLR demapper and a Viterbi decoder.

FIG. 9 illustrates a functional block diagram of an exemplary Kalman filter-based Phase-Locked Loop (PLL) incorporating phase rotation coupled to a simplified LLR demapper and a modified Viterbi decoder

FIG. 10 illustrates a functional block diagram of an exemplary simplified LLR demapper.

FIG. 11 illustrates a functional block diagram of an exemplary scaling circuit of the simplified LLR demapper of FIG. 10.

The use of the same reference symbols in different drawings indicates similar or identical items.

### DETAILED DESCRIPTION

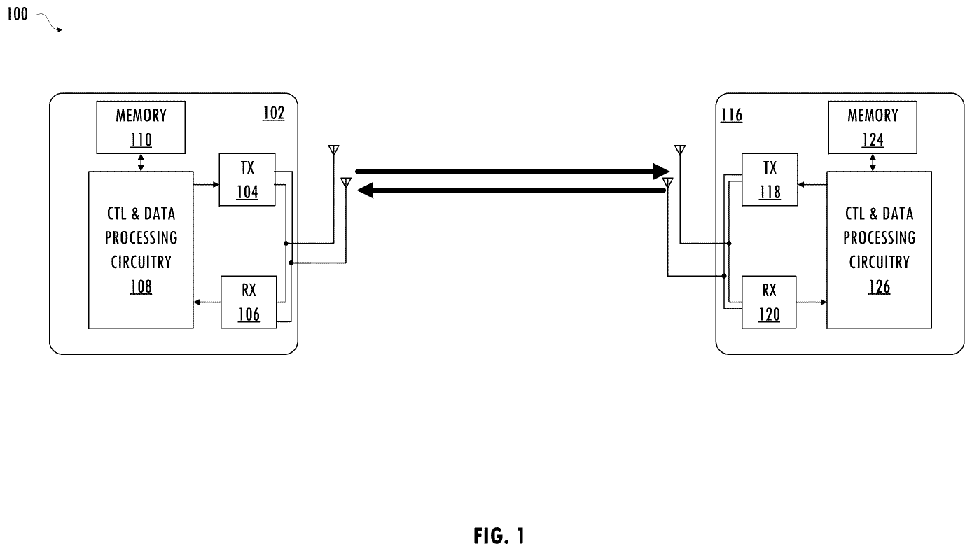

Referring to FIG. 1, in at least one embodiment, wireless communications system 100 includes wireless communications device 102 and wireless communications device 116, which are devices compliant with BLE HDT communications protocol designed for low power and low latency applications. Wireless communications device 102 includes transmitter 104, receiver 106, control & data processing circuitry 108, and memory 110. Wireless communications device 116 includes transmitter 118, receiver 120, control & data processing circuitry 126, and memory 124. Although wireless communications device 102 and wireless communications device 116 are illustrated as each including only one transmitter, one receiver, and two antennas, in other embodiments of wireless communications system 100, wireless communications device 102 or wireless communications device 116 includes multiple transmitters, multiple receivers, additional antennas, or a single antenna with internal circuitry selection or radio frequency switches. Wireless communications system 100 communicates information using a wireless communications protocol that uses 8-PSK modulation, e.g., the BLE HDT communications protocol. However, in other embodiments, wireless communications system 100 can transmit and receive data using PSK modulation compliant with other wireless communications protocols.

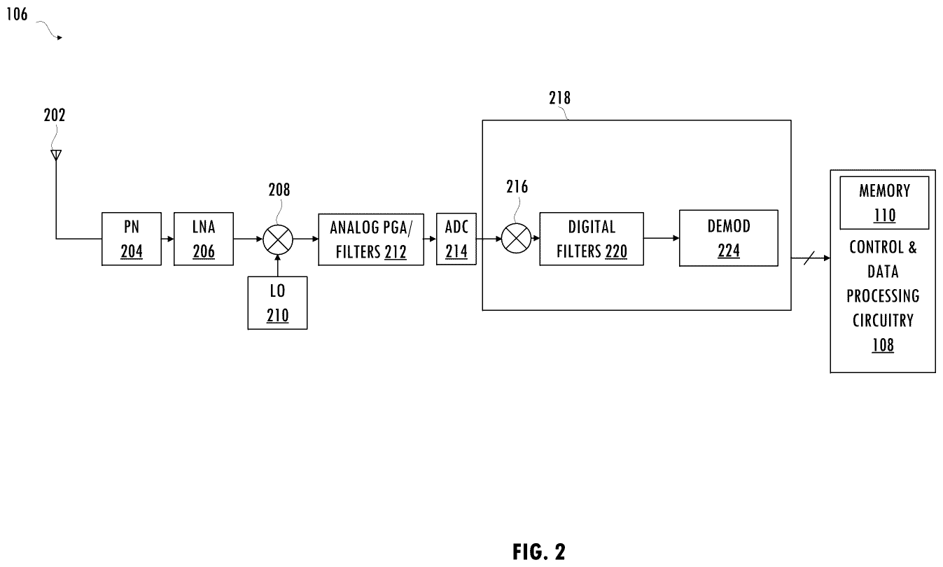

FIG. 2 illustrates an exemplary embodiment of receiver 106 that may be included in the wireless communications devices described above. Antenna 202 provides a radio frequency (RF) signal to passive network 204, which provides impedance matching, filtering, and electrostatic discharge protection. Passive network 204 is coupled to low-noise amplifier 206, which amplifies the RF signal without substantial degradation to the signal-to-noise ratio and provides the amplified RF signal to frequency mixer 208. Frequency mixer 208 performs frequency translation or shifting of the RF signal using a reference or local oscillator signal provided by local oscillator 210. For example, in at least one operational mode of receiver 106, frequency mixer 208 translates the RF signal from a 2.4 GHz frequency band to baseband frequencies centered at DC (i.e., zero-intermediate frequency (ZIF) in a ZIF mode of operation). In another operational mode, receiver 106 is configured as a low-intermediate frequency (LIF) receiver (i.e., in a LIF mode of operation) and frequency mixer 208 translates the RF signal to a low-intermediate frequency (e.g., 100-200 kHz) to reduce or eliminate DC offset and 1/f noise problems of ZIF receivers.

Frequency mixer 208 provides the translated output signal as a set of two signals, an in-phase (I) signal and a quadrature (Q) signal. The I and Q signals are analog time-domain signals. In at least one embodiment of receiver 106, the analog programmable gain amplifier and filters 212 provide amplified and filtered versions of the I and Q signals to analog-to-digital converter (ADC) 214, which converts those versions of the I and Q signals to digital I and Q signals (i.e., I and Q samples). Exemplary embodiments of ADC 214 use a variety of signal conversion techniques (e.g., delta-sigma (i.e., sigma-delta) analog-to-digital conversion). ADC 214 provides the digital I and Q signals to signal processing circuitry 218. In general, signal processing circuitry 218 performs digital signal processing (e.g., frequency translation (e.g., using digital mixer 216), filtering (e.g., using digital filters 220), demodulation, or signal correction) of the digital I and Q signals. In at least one embodiment, signal processing circuitry 218 includes demodulator 224, which recovers or extracts information from digital I and Q signals (e.g., data signals, which were modulated using PSK modulation).

Control & data processing circuitry 108 may perform a variety of functions (e.g., logic, arithmetic, etc.). For example, control & data processing circuitry 108 may use the demodulated data in a program, routine, or algorithm (whether in software, firmware, hardware, or a combination thereof) to perform desired control or data processing tasks. In at least one embodiment, control & data processing circuitry 108, which includes memory 110, controls other circuitry, sub-system, or systems (not shown). In an embodiment, control & data processing circuitry 108 implements a data link layer that includes a state machine, defines state transitions, defines packet formats, performs scheduling, performs radio control, and provides link-layer decryption consistent with at least one wireless communications protocol. Receiver 106 is illustrative only and may vary with the communications protocol implemented by wireless communications system 100 of FIG. 1.

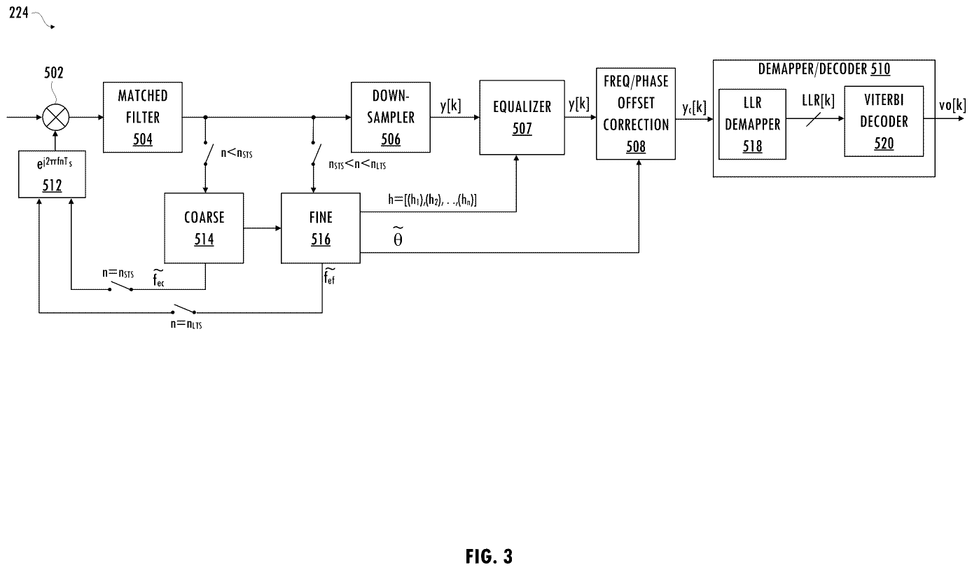

Referring to FIG. 3, in at least one embodiment, demodulator 224 receives a digital intermediate frequency signal (e.g., directly or indirectly from an ADC) and digital mixer 502 frequency shifts the signal to baseband (e.g., ZIF) using a reference signal provided by signal generator 512. Under ideal conditions, the baseband signal provided by mixer 502 is perfectly centered around DC. However, mismatch between the remote oscillator of the transmitting wireless communications device and the local oscillator of the receiving wireless communications device causes a frequency or phase offset in the baseband signal. Matched filter 504 increases the signal-to-noise ratio of the received signal but introduces a delay. During a first phase of receiver processing (e.g., during a short training sequence of a preamble sequence, i.e., n<n_{STS}), coarse timing detection and frequency estimation 514 generates coarse frequency correction [symbol] , which is used to reduce the frequency offset. During a second phase of receiver processing (e.g., during a long training sequence of preamble sequence, i.e., n_{STS}<n≤n_{LTS}), fine timing detection and frequency and phase estimation 516 generates fine frequency error correction [symbol] and initial phase estimate \tilde{θ}, which is used to further reduce the frequency or phase offset. In some embodiments, the fine timing detection and frequency and phase estimation 516 also generates and supplies channel estimate h to equalizer 507, which in an embodiment includes a Linear Minimum Mean Squared Error (LMMSE) equalizer.

In an embodiment of demodulator 224, mixer 502 digitally mixes the received signal with the reference signal (e.g., a tone having a programmable frequency) generated by signal generator 512. Prior to detecting the short training sequence (i.e., n<n_{STS}), signal generator 512 is programmed to generate an intermediate frequency tone having frequency f_{if}, which is used to down convert the received signal to baseband or DC using mixer 502. After detecting the short training sequence, but before detecting the long training sequence (i.e., n_{STS}<n≤n_{LTS}), signal generator 512 is programmed to a coarsely corrected value having frequency f_{if}+ [symbol] to further down-convert the received signal and compensate for frequency offset. After detecting the long training sequence (i.e., n>n_{LTS}), signal generator 512 is programmed to a finely corrected value having frequency f_{if}+ [symbol] + [symbol] . Signal generator 512 adjusts the reference signal by coarse frequency correction [symbol] , or fine frequency correction [symbol] , and thus, mixer 502 applies error correction to the received signal. Downsampler 506 generates received signal y[k], which is a version of the received signal that is downsampled from a sample space to a symbol space, and supplies received signal y[k] to equalizer 507. Frequency/phase offset correction circuit 508 applies initial phase estimate 0 to the received signal and reduces or eliminates any residual phase error to generate corrected received signal y_{c}[k], which is a frequency or phase offset-corrected version of received signal y[k]. Demapper/decoder circuit 510 recovers transmitted data from corrected received signal y_{c}[k] using LLR demapping and Viterbi decoding techniques known in the art.

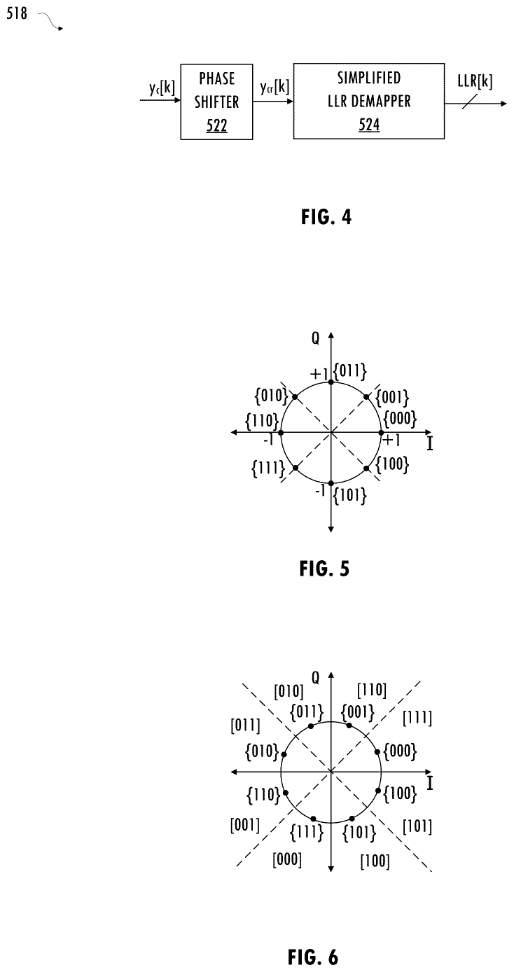

Referring to FIG. 4, a technique for reducing complexity and power consumption of demapper/decoder circuit 510 includes LLR demapper 518 having a phase shifter circuit 522 that rotates corrected received signal y_{c}[k] by a predetermined amount to generate rotated corrected received signal y_{cr}[k]. In at least one embodiment, phase shifter 522 rotates each sample by performing a complex multiply of the sample represented in Cartesian coordinates by π/8. In at least one embodiment, phase shifter 522 rotates the sample by converting the sample to polar coordinates (e.g., using a COordinate Rotation DIgital Computer (CORDIC)), adding a predetermined value corresponding to a phase rotation of π/8, and converting the rotated sample back into Cartesian coordinates (e.g., using a CORDIC). In general, a CORDIC implements known techniques to perform calculations, including trigonometric functions (e.g., an arctangent function) and complex multiplies, without using a multiplier. For example, the only operations the CORDIC uses are addition, subtraction, bit-shift, and table-lookup operations to implement the arctangent function. In other embodiments, a digital signal processor executing firmware or an arctangent circuit is used to convert y[k] from Cartesian coordinates to polar coordinates. FIG. 5 illustrates a constellation diagram of symbols of bits coded using 8-PSK of corrected received signal y_{c}[k]. FIG. 6 illustrates a constellation diagram of rotated symbols of bits coded using 8-PSK of rotated corrected received signal y_{cr}[k]. Rotated symbols (i.e., symbols of rotated corrected received signal y_{cr}[k]) are located in distinct regions (e.g., region [010], [011], [001], [000], [100], [101], [111], or [110]) of the complex plane and are used to reduce complexity of the LLR demapper, as described further below.

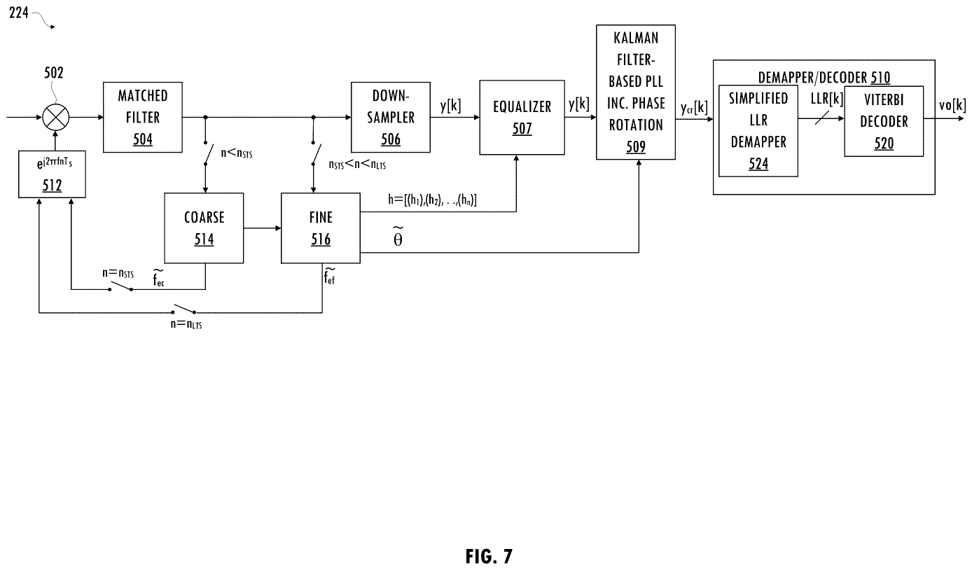

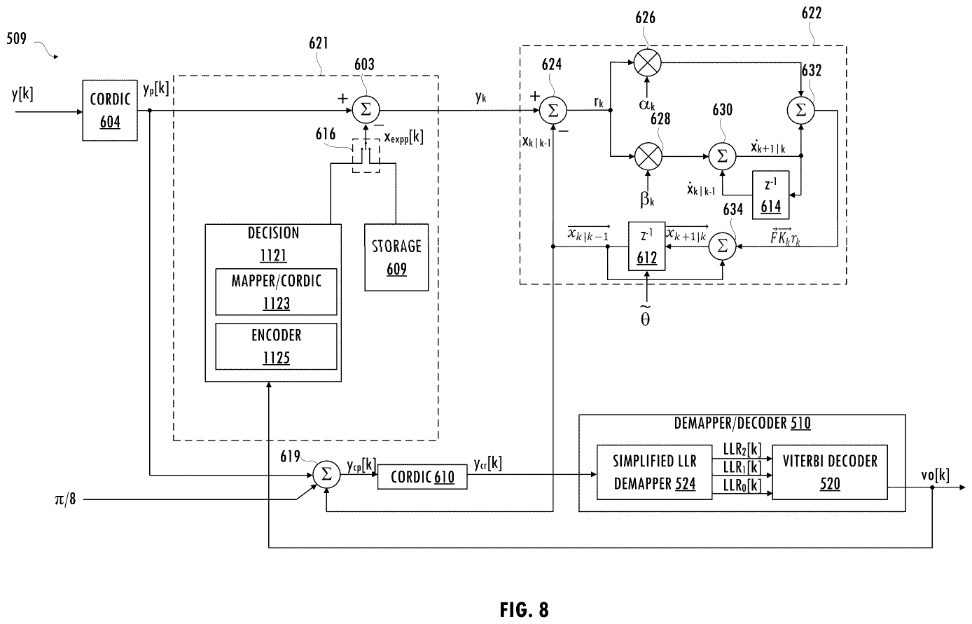

Referring to FIG. 7, in an embodiment of demodulator 224, a Kalman filter-based Phase-Locked Loop (PLL) is included to compensate for phase or frequency offset in the received signal. In an embodiment, Kalman filter-based PLL and phase rotation circuit 509 implements the phase rotation function and phase shifter 522 is excluded from LLR demapper 518. Referring to FIG. 8, in at least one embodiment, Kalman filter-based PLL and phase rotation circuit 509 includes phase detector 621 and Kalman filter 622. In at least one embodiment, CORDIC 604 converts received signal y[k] from Cartesian coordinates to received signal yₚ[k] in polar coordinates. In an embodiment, CORDIC 604 is dedicated to a phase measurement implementation or shared with other operations of the receiver. In an embodiment, CORDIC 604 and CORDIC 610 perform conversions between Cartesian coordinates and polar coordinates outside of the phase-locked loop, although other embodiments perform at least one of these conversions within the phase-locked loop. The phase component of received signal yₚ[k] is a combination of transmitted phase information θ[k] and phase error φ. By computing the difference between the phase component of the received signal yₚ[k] and the expected value of the phase component xₑₓₚₚ[k], phase yₖ is generated and provided as an input to Kalman filter 622.

Kalman filter 622 determines residual phase error signal rₖ by computing the difference between phase yₖ and predicted instantaneous phase x_{k|k-1}. Phase difference circuit 624 provides residual phase error signal rₖ to a proportional integral time-invariant controller including a proportional path (represented by gain circuit 626) and an integral path (represented by gain circuit 628, accumulator 630, and register 614). Summing circuit 632 combines the outputs of the proportional path and the integral path and provides a predicted frequency signal to an integrator represented by accumulator 634 and register 612. The integrator provides the predicted instantaneous phase signal, \vec{x_{(k|k-1)}}, to phase difference circuit 624 and to error correction circuit 619. In at least one embodiment of Kalman filter-based Phase-Locked Loop (PLL) 509, error correction circuit 619 combines a predetermined phase value, e.g., a value that corresponds to a phase rotation of π/8, to yₚ[k] and \vec{x_{(k|k-1)}} to generate frequency or phase offset compensated signal y_{cp}[k]. Accordingly, a separate phase shifter circuit of FIG. 4 is excluded. Referring back to FIG. 8, error correction circuit 619 provides frequency or phase offset compensated signal y_{cp}[k] in polar coordinates to CORDIC 610, which converts the frequency or phase offset compensated signal y_{cp}[k] from polar coordinates to Cartesian coordinates (i.e. frequency or phase offset compensated signal y_{cr}[k]), which is then demapped by simplified LLR demapper 524. In other embodiments of Kalman filter-based Phase-Locked Loop (PLL) 509, the predetermined phase value is combined with received signal yₚ[k] by summing circuit 603 or the predetermined phase value is combined with error signal yₖ by phase difference circuit 624.

In at least one embodiment, phase detector 621 combines received signal yₚ[k] with a reference signal, i.e., expected signal xₑₓₚₚ[k], to extract any frequency offset or phase offset and generate error signal yₖ. In at least one embodiment, phase detector 621 includes select circuit 616, which selectively provides a predetermined signal, e.g., a signal based on the Access Address field of a BLE packet, as expected signal xₑₓₚₚ[k] to summing circuit 603 at time index k. For example, if k≤n_{AAEND}, then select circuit 616 provides a corresponding output of storage 609, e.g., samples of the predetermined Access Address (in Cartesian coordinates, i.e., real and imaginary values corresponding to the in-phase and quadrature values) as expected signal xₑₓₚₚ[k]. If k>n_{AAEND}, then select circuit 616 provides the output of decision circuit 1121 as expected signal xₑₓₚₚ[k]. In general, all BLE packets include the Access Address to identify communications on a physical channel, and to allow a receiver to exclude or ignore packets on different physical channels that are using the same physical interface channels in physical proximity.

In at least one embodiment, decision circuit 1121 generates expected signal Xₑₓₚₚ[k], which is used as a reference signal, by comparing a corrected version of the received signal to predetermined modulated values and provides the nearest predetermined modulated value (in polar coordinates) as expected signal xₑₓₚₚ[k]. Viterbi decoder 520 provides Viterbi decoded signal vo[k] to decision circuit 1121. Encoder 1125 re-encodes Viterbi decoded signal vo[k] and mapper/CORDIC circuit 1123 maps the re-encoded signal to phase-shift keying symbols and converts those modulated symbols to polar coordinates to generate expected signal xₚ[k]. In other embodiments of Kalman filter based phase-locked loop 509 where the CORDIC is within the loop, mapper/CORDIC circuit 1123 is configured to forgo the CORDIC operation that converts the modulated symbols to polar coordinates.

Referring to FIGS. 7 and 8, in an embodiment of demodulator 224, demapper/decoder circuit 510 includes simplified LLR demapper 524 and a conventional decoder that implements conventional maximum likelihood decoding and Viterbi decoding techniques. In an embodiment, demapper/decoder circuit 510 includes simplified LLR demapper 524, which demaps constellation points of frequency or phase offset compensated signal y_{cr}[k]. In an embodiment, each corrected received symbol y_{cr}[k] includes an in-phase and quadrature component and simplified LLR demapper 524 generates a corresponding soft decision output. In an embodiment, the soft-decision outputs are LLR₀[k], LLR₁[k], LLR₂[k]] for 8-PSK and are real values indicating a reliability of the decision.

In an embodiment, Viterbi decoder 520 implements a conventional Viterbi algorithm for decoding LLR values LLR₀[k], LLR₁[k], LLR₂[k]] where the bitstream has been encoded using a convolutional code or trellis code before modulation. Viterbi decoder 520 uses branch metrics (e.g., log-likelihood measure of the probability of a corresponding state transition of a state diagram) and path metrics (e.g., sum of the branch metrics of the branches that a path traverses) to find the most likely received data symbols (e.g., by identifying a minimum distance path through a trellis diagram corresponding to conventional maximum likelihood decoding and Viterbi decoding techniques). Each path metric corresponds to a number of errors on a maximum-likelihood path to an associated state and each branch metric corresponds to a Hamming distance between received parity and expected parity or a reliability metric for each received symbol.

In an embodiment, demapper/decoder circuit 510 provides the demapped and decoded received symbols output by the Viterbi decoder to Kalman filter based phase-locked loop 509 for use in generating expected signal xₑₓₚₚ[k], which is used by the phase detector as a reference signal for generating phase yₖ. Viterbi decoder 520 provides Viterbi decoded signal vo[k] to decision circuit 1121. In the tracking mode of operation, phase detector 621 extracts the frequency offset using decision circuit 1121. Encoder 1125 re-encodes Viterbi decoded signal vo[k] and mapper/CORDIC circuit 1123 maps the re-encoded signal to phase-shift keying or quadrature amplitude modulation symbols and converts those modulated symbols to polar coordinates to generate expected signal Xₑₓₚₚ[k]. In other embodiments of Kalman filter based phase-locked loop 509 where the CORDIC is within the PLL, mapper/CORDIC circuit 1123 is configured to forgo the CORDIC operation that converts the modulated symbols to polar coordinates. Viterbi decoder 520 introduces a substantial delay before providing a sample of Viterbi decoded signal vo[k] corresponding to a sample of received signal y[k]. To accommodate that latency, the complexity of Kalman filter phase-locked loop 509 increases substantially to account for predicting symbols ahead.

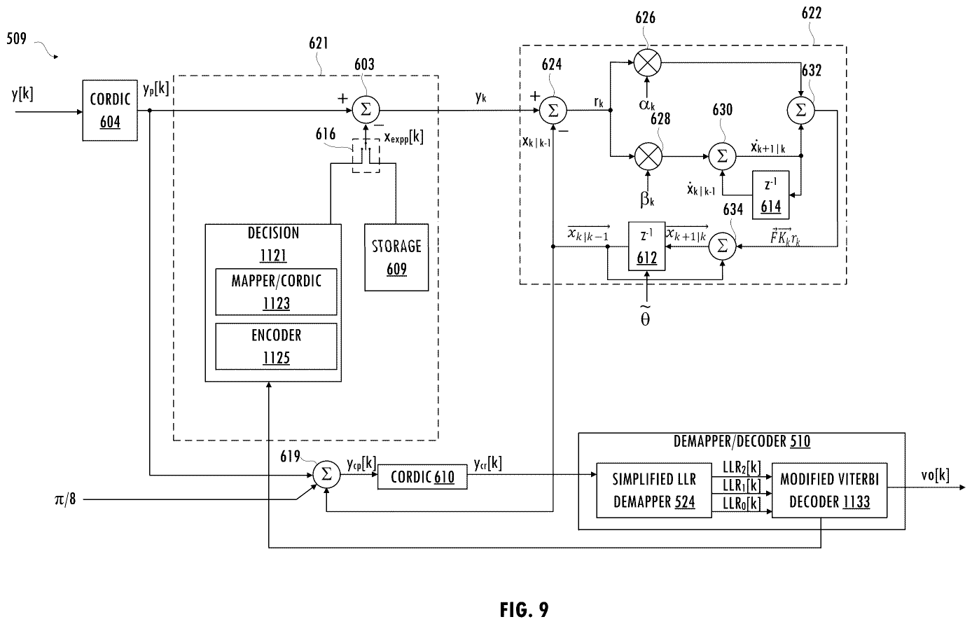

In the embodiment of FIG. 9, a technique for simplifying a Kalman filter based phase-locked loop for use with a re-encoding-based phase detector includes using modified Viterbi decoder 1133 that provides a preliminarily decoded symbol as an output based on at least one soft-decision signal LLR[k] of a corrected received signal that is corrected based on the error between a reference signal and a baseband version of a received radio frequency signal. These techniques are described in U.S. patent application Ser. No. 18/392,416, filed on Dec. 21, 2023, naming Xushuai Qu and Guner Arslan as inventors, entitled “Kalman Filter Based Phase-Locked Loop with Re-encoding Phase Detector,” which application is hereby incorporated herein.

Referring to FIG. 7, a conventional soft-decision algorithm, the in-phase component of the received signal and the quadrature component of the received signal are regarded as two independent random variables and calculation of the LLR values is based on a maximum a posteriori (MAP) criterion. A simplified LLR calculation calculates a minimum Euclidian distance between the received symbol and the constellation points referring to bit 1 and the constellation points referring to bit 0:

$$LLR ( k ) = {\vert r - {c}^{*} ( k , 1 ) \vert}^{2} - {\vert r - {c}^{*} ( k , 0 ) \vert}^{2} ,$$

$$where$$

$${c}^{*} ( k , A ) {=}^{Δ} c ( {min}_{b : {b}_{k} = A} {\vert r - c ( b ) \vert}^{2} ) ; and$$

$$A = ∈ \{ 0 , 1 \} .$$

This approximation requires computing four multiplications and five subtractions. This approximation can be simplified as follows:

$$LLR ( k ) = 2 < r {,}^{2} {c}^{*} ( k , 0 ) - {c}^{*} ( k , 1 ) > + {\vert {c}^{*} ( k , 1 ) \vert}^{2} - {\vert {c}^{*} ( k , 0 ) \vert}^{2} ,$$

$$where$$

$$< r , c > {=}^{Δ} real ( r ) real ( c ) + imag ( r ) imag ( c ) ,$$

and
the conditional probability density functions are equal for bit values equal to zero and bit values equal to one.

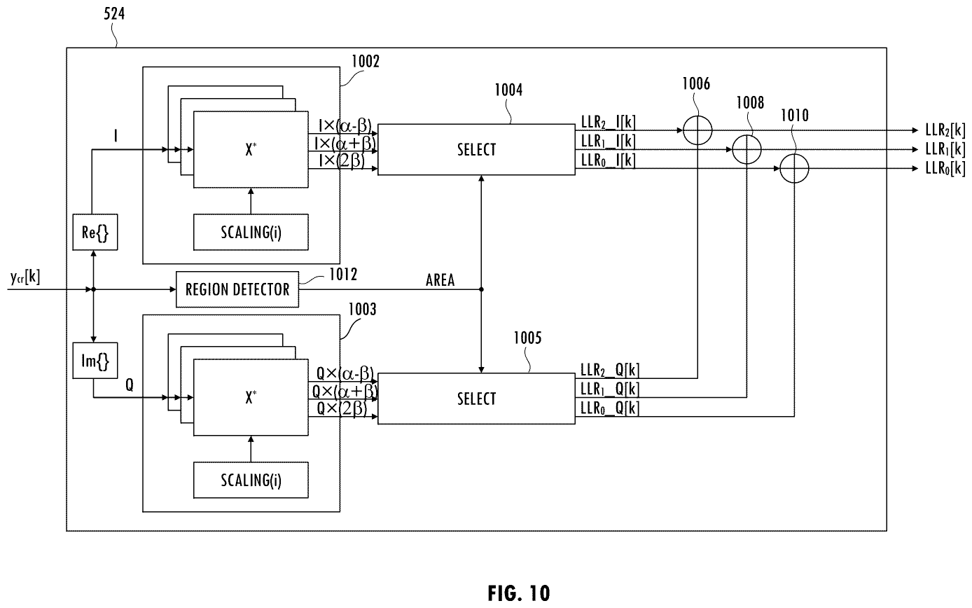

Referring to FIGS. 7 and 10, in at least one embodiment of demapper/decoder circuit 510, simplified LLR demapper 524 generates one LLR value for each coded bit of the received signal. For example, 8-PSK the received symbol has three coded bits and simplified LLR demapper 524 generates three LLR values. Simplified LLR demapper 524 includes scaling circuits 1002 and 1003, region detector 1012, select circuits 1004 and 1005 and summing circuits 1006, 1008, and 1010. Region detector 1012 determines control signal AREA, which corresponds to region of the rotated 8-PSK constellation diagram of rotated corrected received signal y_{cr}[k]. For example, region detector 1012 compares the in-phase (i.e., real) component of rotated corrected received signal y_{cr}[k] to zero, compares the quadrature (i.e., imaginary) component of rotated corrected received signal y_{cr}[k] to zero, and compares the absolute value of the in-phase component of rotated corrected received signal y_{cr}[k] to the quadrature component of rotated corrected received signal y_{cr}[k]. Region detector 1012 generates control signal AREA based on those comparisons.

Referring to FIGS. 6, 7, and 10, in an embodiment, control signal AREA is three bits wide and corresponds to a region in the complex plane of a symbol of rotated

corrected received signal y_{cr}[k] (e.g., region [010], [011], [001], [000], [100], [101], [111], or [110]). Region detector 1012 generates control signal AREA by determining the quadrant in the complex plane of rotated corrected received signal y_{cr}[k] and then determining which state in that quadrant corresponds to rotated corrected received signal y_{cr}[k]. For example, region detector 1012 generates control signal AREA having a value from “000” to “111” by comparing the value of the in-phase component of rotated corrected received signal y_{cr}[k] (i.e., Re{y_{cr}[k]}=I) to zero, comparing the value of the quadrature component of rotated corrected received signal y_{cr}[k] (i.e., Im{y_{cr}[k]}=Q) to zero, and then comparing the absolute value of the in-phase and quadrature components to each other:
pos_I=‘1’ when I>0, and is ‘0’ otherwise;
pos_Q=‘1’ when Q>0, and is ‘0’ otherwise;

$$I\_o \_Q = abs ( I ) > abs ( Q ) ; and$$

$$AREA = \{ pos\_I , pos\_Q , I\_o \_Q \} .$$

In other embodiments, other mappings of rotated corrected received signal y_{cr}[k] to values of control signal AREA are used.

In an embodiment, select circuit 1004 provides an in-phase component of the LLR value for each coded bit of a received symbol selected from scaled values of the in-phase component of a symbol of rotated corrected received signal y_{cr}[k] illustrated in Table 1, according to control signal AREA, where

$${s}_{1} = α + β ;$$

$${s}_{2} = α - β ; and$$

$${s}_{3} = 2 β ,$$

$$cos \frac{π}{8} = \frac{\sqrt{2 + \sqrt{2}}}{2} = \frac{∝}{2} ;$$

$$sin \frac{π}{8} = \frac{\sqrt{2 - \sqrt{2}}}{2} = \frac{β}{2} ;$$

$$∝ = \sqrt{2 + \sqrt{2}} , and$$

$$β = \sqrt{2 - \sqrt{2}} .$$

TABLE 1
In-Phase Operation

| AREA | LLR2_I | LLR1_I | LLR0_I |
|---|---|---|---|
| 000 | −I × (α − β) | I × 2β | −I × (α − β) |
| 001 | 0 | I × (α + β) | −I × (α − β) |
| 010 | I × (α − β) | I × 2β | −I × (α − β) |
| 011 | 0 | I × (α + β) | −I × (α − β) |
| 100 | I × (α − β) | I × 2β | I × (α − β) |
| 101 | 0 | I × (α + β) | I × (α − β) |
| 110 | −I × (α − β) | I × 2β | I × (α − β) |
| 111 | 0 | I × (α + β) | I × (α − β) |

Similarly, select circuit 1005 provides a quadrature component of the LLR value for each coded bit of a received symbol selected from scaled values of the quadrature component of a symbol of rotated corrected received signal y_{cr}[k] illustrated in Table 2, according to control signal AREA.

TABLE 2
Quadrature Operation

| AREA | LLR2_Q | LLR1_Q | LLR0_Q |
|---|---|---|---|
| 000 | Q × (α + β) | 0 | Q × (α − β) |
| 001 | Q × 2β | −Q × (α − β) | Q × (α − β) |
| 010 | Q × (α + β) | 0 | −Q × (α − β)) |
| 011 | Q × 2β | −Q × (α − β) | −Q × (α − β)) |
| 100 | Q × (α + β) | 0 | Q × (α − β) |
| 101 | Q × 2β | −Q × (α − β) | Q × (α − β) |
| 110 | Q × (α + β) | 0 | −Q × (α − β)) |
| 111 | Q × 2β | −Q × (α − β) | −Q × (α − β)) |

These values are representative only and other values may be used (e.g., different values for α and β are used for different numbers of bit quantization and for different phase rotation).

In an embodiment, the scaling functions performed by scaling circuit 1002 and scaling circuit 1003 are implemented by multiplication operations. However, the values of predetermined scalars s₁, s₂, and s₃ are constant. Therefore, in other embodiments, the scaling function is implemented by constant shift and addition operations instead of multiplication operations, thereby reducing circuit area as compared to embodiments that use multiplier circuits. In an embodiment, the scaling functions are performed using three shift-and-add operations for the in-phase components and shift-and-add operations for the quadrature components. For example, if α and β are quantized by 11 bits, then

$${s}_{1} = α + β = 5353 = 0 b 1010011101000 = {2}^{12} + {2}^{10} + {2}^{7} + {2}^{6} + {2}^{5} + {2}^{3} .$$

$${s}_{2} = α - β = 2217 = 0 b 0100010101001 = {2}^{11} + {2}^{7} + {2}^{5} + {2}^{3} + {2}^{0} ; and$$

$${s}_{3} = 2 β = 3135 = 0 b 0110000111111 = {2}^{11} + {2}^{10} + {2}^{5} + {2}^{4} + {2}^{3} + {2}^{2} + {2}^{1} + {2}^{0} .$$

Scaling circuit 1002 computes the product of the in-phase component of rotated corrected received signal y_{cr}[k] (e.g., Re{y_{cr}[k]}=I} with each of the predetermined scalars to generate scaled component values (e.g., I×s₁; I×s₂; and I×s₃) used in the in-phase demapping operation (e.g., LLR0_I, LLR1_I, and LLR2_I of Table 1). Similarly, scaling circuit 1003 computes the product of the quadrature component of rotated corrected received signal y_{cr}[k] (e.g., Im{y_{cr}[k]}=Q) with each of the predetermined scalars to generate scaled component values (e.g., Q×s₁; Q×s₂; and Q×s₃) used in the quadrature demapping operation (e.g., LLR0_Q, LLR1_Q, and LLR2_Q of Table 2).

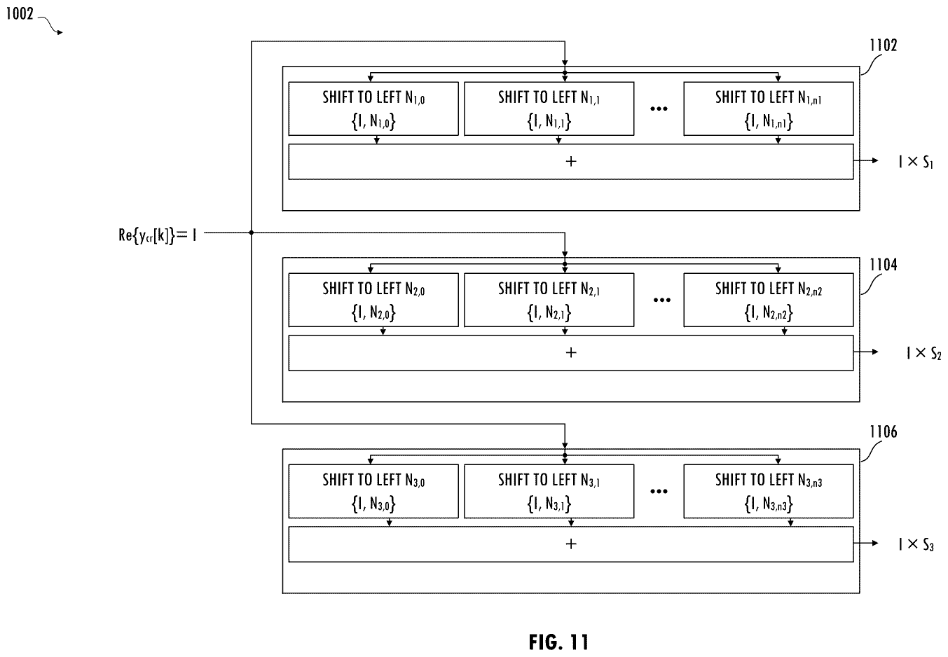

Referring to FIGS. 10 and 11, in an exemplary embodiment of scaling circuit 1002, scaling circuit 1002 generates partial products for each of the scaling factors by shifting/by an appropriate number of bit places and adding the partial products together to generate each scaled component value. For example, shifter 1102 shifts the binary value of I to the left by N_{1,0}=12, N_{1,1}=10, N_{1,2}=7, N_{1,3}=6, N_{1,4}=5, and N_{1,5}=3 and adds the shifted values to generate I×s₁; shifter 1104 shifts the binary value of I to the left by N_{2,0}=11, N_{2,1}=7, N_{2,2}=5, N_{2,3}=3, and N_{2,4}=0, and adds the shifted values generate I×s₂; and shifter 1106 shifts the binary value of I to the left by N_{2,0}=11, N_{2,1}=10, N_{2,2}=5, N_{2,3}=4, N_{2,4}=3, N_{2,5}=2, N_{2,6}=1, and N_{2,7}=0, and adds the shifted values generate I×s₃. A product for each of the scaled component values is used as is, negated, or zeroed out to generate the LLR component value for each coded bit of the symbol.

Select circuit 1004 and 1005 use control signal AREA to select from a product generated using each of the scaling factors, negated values of the products, or zeroed values to generate each in-phase component of an LLR value and each quadrature component of the LLR value, respectively. Summing circuits 1006, 1008, and 1010 combine the in-phase components of the LLR values with corresponding quadrature components of the LLR values to generate the LLR value for each coded bit of the symbol (e.g., LLR₂[k], LLR₁[k], and LLR₀[k]). Although the simplified LLR is described with reference to 8-PSK, techniques consistent with the description herein use other modulation schemes. For example, an embodiment uses 16-PSK modulation, a phase shifter circuit rotates samples by π/16, simplified LLR demapper 524 uses corresponding predetermined scalars, and region detector 1012 uses comparisons to identify the quadrant and one or more additional comparisons to identify a corresponding region within the quadrant of the complex plane.

Thus, techniques for reducing the complexity and power consumption of calculating the LLR values for use in a demapper of a PSK demodulator are described. The description of the invention set forth herein is illustrative and is not intended to limit the scope of the invention as set forth in the following claims. For example, while the invention has been described in an embodiment in which BLE HDT communications protocol is used, other communications protocols using PSK modulation may be used. The terms “first,” “second,” “third,” and so forth, as used in the claims, unless otherwise clear by context, are to distinguish between different items in the claims and do not otherwise indicate or imply any order in time, location, or quality. For example, “a first received signal” and “a second received signal” do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A receiver of a digital communications system using shift keying digital modulation, the receiver comprising:
a receive path configured to provide a baseband received symbol;
a phase shifting circuit configured to rotate the baseband received symbol to generate a phase-rotated received symbol; and
a log-likelihood ratio (LLR) demapper configured to generate an LLR value for each coded bit of the phase-rotated received symbol based on the phase-rotated received symbol and a set of predetermined scalar values.

2. The receiver as recited in claim 1 wherein the LLR demapper comprises:
a scaling circuit configured to scale an in-phase component of the phase-rotated received symbol by each of a plurality of predetermined scalar values to generate a plurality of scaled in-phase symbol components and configured to scale a quadrature component of the phase-rotated received symbol by each of the plurality of predetermined scalar values to generate a plurality of scaled quadrature symbol components.

3. The receiver as recited in claim 1 wherein the LLR demapper comprises:
a first select circuit configured to provide a selected scaled in-phase symbol component for each coded bit of the phase-rotated received symbol based on a plurality of scaled in-phase symbol components and a control code;
a second select circuit configured to provide a selected scaled quadrature symbol component for each coded bit of the phase-rotated received symbol based on a plurality of scaled quadrature symbol components and the control code; and
a summing circuit configured to combine each selected scaled in-phase symbol component and corresponding selected scaled quadrature symbol component to generate the LLR value for each coded bit of the phase-rotated received symbol.

4. The receiver as recited in claim 1 wherein the LLR demapper comprises:
a region detector configured to provide a control code based on a first comparison of an in-phase component of the phase-rotated received symbol to zero, a second comparison of a quadrature component of the phase-rotated received symbol to zero, and a comparison of the in-phase component of the phase-rotated received symbol to the quadrature component of the phase-rotated received symbol.

5. The receiver as recited in claim 4 wherein the control code corresponds to a region of a Phase-Shift Keying (PSK) constellation diagram identified by the phase-rotated received symbol.

6. The receiver as recited in claim 1 wherein the shift keying digital communications system is an 8-Phase-Shift Keying (PSK) digital communications system, the phase shifting circuit rotates the baseband received symbol by π/8 counterclockwise with respect to Cartesian coordinate axes of a constellation diagram, and the received symbol includes three coded bits.

7. The receiver as recited in claim 1 wherein the phase shifting circuit adds a predetermined value corresponding to the rotation in polar coordinates to a frequency and phase offset corrected symbol in polar coordinates.

8. The receiver as recited in claim 1 wherein the phase shifting circuit is a complex multiplier configured to perform a complex multiplication of the phase-rotated received symbol in Cartesian coordinates with a predetermined value corresponding to the rotation in Cartesian coordinates.

9. The receiver as recited in claim 1 wherein the phase shifting circuit is a Kalman filter PLL included in a phase or frequency offset correction circuit.

10. A method for calculating log-likelihood ratio (LLR) values in a digital communications system using shift keying digital modulation, the method comprising:
phase shifting a baseband received symbol to generate a phase-rotated received symbol; and
generating an LLR value for each coded bit of the phase-rotated received symbol based on the phase-rotated received symbol and a set of predetermined scalar values.

11. The method as recited in claim 10 wherein generating the LLR value for each coded bit of the phase-rotated received symbol comprises:
scaling an in-phase component of the phase-rotated received symbol by each of a plurality of predetermined scalar values to generate a plurality of scaled in-phase symbol components; and
scaling a quadrature component of the phase-rotated received symbol by each of the plurality of predetermined scalar values to generate a plurality of scaled quadrature symbol components.

12. The method as recited in claim 10 wherein generating the LLR value for each coded bit of the phase-rotated received symbol comprises:
selecting from a plurality of scaled in-phase symbol components according to a control code, a selected scaled in-phase symbol component for each coded bit of the phase-rotated received symbol;
selecting from a plurality of scaled quadrature symbol components according to the control code, a selected scaled quadrature symbol component for each coded bit of the phase-rotated received symbol; and
combining each selected scaled in-phase symbol component and corresponding selected scaled quadrature symbol component to generate the LLR value for each coded bit of the phase-rotated received symbol.

13. The method as recited in claim 10 wherein generating the LLR value for each coded bit of the phase-rotated received symbol comprises:
providing a control code based on a first comparison of an in-phase component of the phase-rotated received symbol to zero, a second comparison of a quadrature component of the phase-rotated received symbol to zero, and a comparison of the in-phase component of the phase-rotated received symbol to the quadrature component of the phase-rotated received symbol.

14. The method as recited in claim 13 wherein the control code corresponds to a region of a Phase-Shift Keying (PSK) constellation diagram identified by the phase-rotated received symbol.

15. The method as recited in claim 10 wherein the shift keying digital communications system is an 8-Phase-Shift Keying (PSK) digital communications system, the phase shifting circuit rotates the baseband received symbol by π/8 counterclockwise with respect to Cartesian coordinate axes of a constellation diagram, and the received symbol includes three coded bits.

16. The method as recited in claim 10 wherein the phase shifting comprises adding a predetermined value corresponding to the rotation in polar coordinates to a frequency and phase offset corrected symbol in polar coordinates.

17. The method as recited in claim 10 wherein the phase shifting comprises performing a complex multiplication of the phase-rotated received symbol in Cartesian coordinates with a predetermined value corresponding to the rotation in Cartesian coordinates.

18. The method as recited in claim 10 further comprising:
compensating for a phase or frequency offset in the baseband received symbol using Kalman filtering the baseband received symbol,
wherein the phase shifting is performed by the compensating.

19. An apparatus comprising:
means for phase shifting a baseband received symbol to generate a phase-rotated received symbol; and
means for generating a log-likelihood ratio soft-decision output symbol based on the phase-rotated received symbol and a set of predetermined scalar values.

20. The apparatus as recited in claim 19 wherein the apparatus is an 8-Phase-Shift Keying digital communications system, and the baseband received symbol is phase shifted by π/8 counterclockwise with respect to Cartesian coordinate axes of a constellation diagram.
